(19) United States
(12) Patent Application Publication
(10) Pub. No.: US 2014/0260832 A1
(43) Pub. Date: Sep. 18, 2014

(54) MULTI-FUNCTIONAL WRENCH SOCKET

(71) Applicant: YUN CHAN INDUSTRY CO., LTD., New Taipei City (TW)

(72) Inventor: FU-JUI HSIAO, New Taipei City (TW)

(73) Assignee: YUN CHAN INDUSTRY CO., LTD., New Taipei City (TW)

(21) Appl. No.: 13/831,949

(22) Filed: Mar. 15, 2013

(51) Int. Cl. B25B 23/00; B25B 15/00

(52) U.S. Cl. CPC B25B 23/0035; B25B 15/004
USPC 81/438; 81/124.6

(57) ABSTRACT

The present invention is related to a multi-functional wrench socket comprising a socket main body; an inner wall defined in an internal of said socket main body and having a rectangular form; and an outer wall defined on a surface of said socket main body and having a polygonal form. By providing an inner rectangular form and an outer polygonal form on the wrench socket, the wrench socket can be adapted onto any type of hand tools or pneumatic driven tools with ease such that the operation thereof is facilitated. In addition, the wrench socket of the present invention can be operated on its own without cooperation of wrenches but with user hands only. Therefore, the wrench socket of the present invention is applicable to various fields of uses with great convenience and enhanced technical effects.

### (a) TECHNICAL FIELD OF THE INVENTION

the present invention is related to a wrench socket, in particular, to a multi-functional wrench socket capable of being used as a standalone hand tool means for various mechanical operations and rotations.

### (b) DESCRIPTION OF THE PRIOR ART

Hand tools of such as box-end wrenches and torque wrenches are commonly used for fastening nuts and bolts. Among the various types of torque wrenches, there is one type of torque wrench having a square cylinder protruded outward from one end thereof and a steel ball slightly protruded from the lateral side of the square cylinder. Such type of torque wrench also includes a sleeve having a square hole provided on one end thereof to be matched with the square cylinder of the wrench; whereas the other end of the sleeve is provided with a mounting portion of either a hexagonal or dodecagonal shape to be mounted onto bolt heads, screw nuts or wrench ends. One end of the wrench can be such as a flat-head screw driver, cross-head driver and hexagonal cylinder; whereas the other end of the wrench is always equipped with a hexagonal cylinder to be fitted onto a sleeve of either a hexagonal or dodecagonal shape.

Unfortunately, it is found that most of known wrench sockets are of the form of a mere square shape or other shapes that cannot be integrated effectively with conventional wrenches. There is a need for an improvement for a wrench socket to facilitate the use and operation of hand tools such as wrenches such that operation speed and user convenience can be advantageously enhanced.

### SUMMARY OF THE INVENTION

A primary objective of the present invention is to provide a multi-functional wrench socket with facilitated operation allowing users to operate easily by hands and such that the multi-functional wrench socket requires no physical mounting or fitting onto wrenches to be operated by users properly.

To achieve the aforementioned objective, the present invention provides a multi-functional wrench socket comprising a socket main body; an inner wall defined in an internal of the socket main body and having a rectangular form; and an outer wall defined on an outer surface of the socket main body and having a polygonal form.

According to the abovementioned structure of the multi-functional wrench socket of the present invention, the multi-functional wrench socket is provided with a combination of an inner rectangular shape and an outer polygonal form, including such as rectangular, hexagonal, octagonal and dodecagonal forms, in order to facilitate the operation of wrenches with significantly reduced time in the change of the wrench sockets. Furthermore, the multi-functional wrench socket of the present invention is provided with anti-slip portions such that during the time when the wrench socket is operating without the aid of pneumatic or hand tools including such as wrenches, the wrench socket can still be operated as a standalone unit by the user as a hand tool

### BRIEF DESCRIPTION OF THE DRAWINGS

FIG. 1 is a first perspective view of a preferred embodiment of a multi-functional wrench socket of the present invention;

FIG. 2 is a second perspective view of the preferred embodiment of the multi-functional wrench socket of the present invention;

FIG. 3 is an illustration showing a first state of use of the preferred embodiment of the multi-functional wrench socket of the present invention;

FIG. 4 is another illustration showing a second state of use of the preferred embodiment of the multi-functional wrench socket of the present invention;

FIG. 5 is another illustration showing a third state of use of the preferred embodiment of the multi-functional wrench socket of the present invention; and

FIG. 6 is another illustration showing a fourth state of use of the preferred embodiment of the multi-functional wrench socket of the present invention.

### DETAILED DESCRIPTION OF THE PREFERRED EMBODIMENTS

Please refer to FIG. 1 and FIG. 2 showing a first perspective view and a second perspective view of a preferred embodiment of a multi-functional wrench socket of the present invention respectively. As shown in the figures, the multi-functional wrench socket of the present invention comprises:

a socket main body 1;

an inner wall 11 defined in an internal of the socket main body 1 and having a rectangular form; and

an outer wall 12 defined on a surface of the socket main body 1 and having a polygonal form.

According to the aforementioned multi-functional wrench socket of the present invention, the socket main body 1 comprises a plurality of ratchets 14 formed on an outer surface opposite from the outer wall 12 thereof. In addition, the socket main body 1 further comprises at least one anti-slip portion 15 defined between the plurality of ratchets 14 and the outer wall thereof 12. The ratchet 14 can be of a shape selected from any one of the following: a flat-head shape, a cross-head shape, a polygonal shape, a box-end shape and a torx shape. Furthermore, the polygonal form of the outer wall 12 can be selected from any one of the following: a rectangular form, a hexagonal form, an octagonal form and a dodecagonal form.

Based on the aforementioned configuration and structural design of the multi-functional wrench socket of the present invention, the following further provides description in relation to the state of use and operation of the wrench socket of the present invention in more detail. Please refer to FIG. 3˜FIG. 6 that show illustrations of first to fourth states of use of the multi-functional wrench socket of the present invention. As shown in the figures, in this preferred embodiment of present invention, the inner wall 11 thereof is configured to be of such as an inner rectangular form or the outer wall 12 thereof is configured to be of such as a rectangular, hexagonal, octagonal or dodecagonal form in order to cooperate and operate with a wrench. The multi-functional wrench socket of the present invention also comprises one end having a plurality of ratchets formed thereon to cooperate correspondingly with such as a drilling tool of either a hexagonal or dodecagonal shape for the operation of rotations. On the other hand, during the time when the wrench socket of the present invention is not cooperating or being fitted onto wrenches, the user can still operate the wrench socket by holding onto the anti-slip portions 15 in order to perform rotational operations. Due to the advantageous design of the anti-slip portions 15 on the wrench socket of the present invention, the friction between the socket main body 1 and the user hand is effectively increased such that the operation of the wrench socket of the present invention is facilitated and improved. It can be understood that the applicable field of use of the wrench socket of the present invention is diverse and of a wide range; therefore, the present invention is illustrated with exemplary examples to demonstrate the principles of the wrench socket cooperating with different types of hand tools and wrenches and any addition and modification of component parts of the present invention shall too be considered to be within the scope of the present invention.

In view of the above along with the accompanied drawings, the multi-functional wrench socket of the present invention demonstrates at least the following merits:
1. By providing the outer wall 12 with a polygonal form including such as a rectangular form, a hexagonal form, an octagonal form or a dodecagonal form in addition to the inner wall 11 with a rectangular form, the wrench socket of the present invention can be easily and conveniently adapted to various types of hand tools including wrenches such that the time involved in the change of wrench sockets can be significantly reduced.
2. By providing the anti-slip portions 15 and the ratchets 14 on the wrench socket of the present invention, the operation of the present invention can be facilitated with enhanced technical effects.

What is claimed is:

1. A multi-functional wrench socket, comprising:
a socket main body;
an inner wall defined in an internal of said socket main body and having a rectangular form; and
an outer wall defined on a surface of said socket main body and having a polygonal form.

2. The multi-functional wrench socket according to claim 1, wherein said socket main body comprises a plurality of ratchets formed on an outer surface opposite from said outer wall thereof.

3. The multi-functional wrench socket according to claim 2, wherein said socket main body comprises at least one anti-slip portion defined between said plurality of ratchets and said outer wall thereof.

4. The multi-functional wrench socket according to claim 2, wherein said ratchet is of a shape selected from any one of the following: a flat-head shape, a cross-head shape, a polygonal shape, a box-end shape and a torx shape.

5. The multi-functional wrench socket according to claim 1, wherein said polygonal form of said outer wall is selected from any one of the following:
a rectangular form, a hexagonal form, an octagonal form and a dodecagonal form.
